(19) United States
(12) Patent Application Publication
(10) Pub. No.: US 2011/0040792 A1
(43) Pub. Date: Feb. 17, 2011

(54) Stored Object Replication

(76) Inventor: Russell Perry, Bristol (GB)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/540,336

(22) Filed: Aug. 12, 2009

(51) Int. Cl. G06F 17/30

(52) U.S. Cl. 707/783; 707/E17.055; 707/E17.005

(57) ABSTRACT

The number of replicas of an object to be stored is determined, at least in part, as a function of an access control policy for that object.

### BACKGROUND

Herein, related art is described for expository purposes. Related art labeled “prior art”, if any, is admitted prior art; related art not labeled “prior art” is not admitted prior art.

Storing replicas of a digital asset (e.g., document, multimedia object, executable file, or other object) in separate locations provides for: 1) continuous access to at least one replica even in the event of a failure of a storage system containing one of the replicas; and 2) fewer bottlenecks through load balancing when plural users attempt to access the same object which in the extreme could cause a server failure. However, each replica requires additional storage and thus incurs a cost associated with that storage. Also, if the object can be modified, then there is a cost associated with keeping all replicas up to date. Thus, there is a tradeoff between utility and cost in determining the number of object replicas to maintain. This tradeoff can be affected by the frequency with which an object is accessed and the type of those accesses.

An access can either modify the object, which is a write type of operation, or it can leave the object unchanged, which is a read type of operation. Objects that are frequently accessed are relatively likely to cause bottlenecks; also, an interruption in the availability of a frequently accessed object is relatively likely to be considered objectionable. For objects that can be modified, all their replicas have to be kept synchronized, so it is desirable to reduce the number of replicas to limit the cost of synchronization. In view of this, the number of replicas of an object can be adjusted according to some function of access frequency and type. Given a history of the object access patterns by users of the system, it is possible to determine correlations or similarities between users. For example, Amazon.com uses this in their Recommender systems to suggest books or other items that might be of interest to a repeat customer.

### BRIEF DESCRIPTION OF THE DRAWINGS

FIG. 1 is a schematic diagram of a system providing for object storage.

FIG. 2 is a flow chart of a method implemented in the context of the system of FIG. 1.

### DETAILED DESCRIPTION

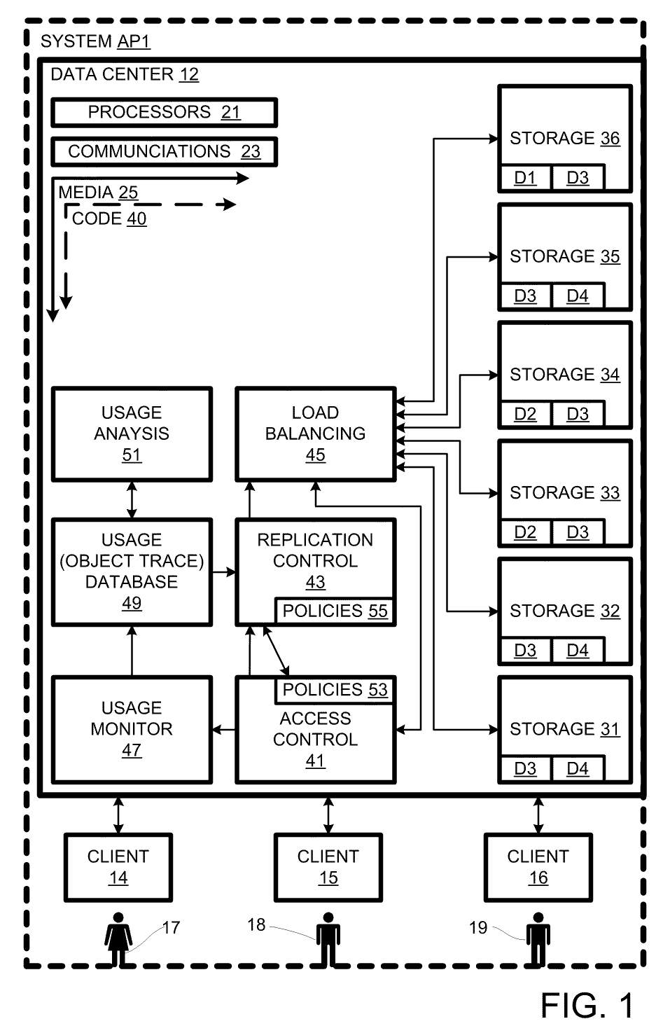

In system AP1 of FIG. 1, an initial “replication” number of replicas is selected as a function of access control policies, e.g., associated with the object itself or with a selected storage location. This allows a useful replication value to be selected when an object is first “published” (stored so as to be accessible to authorized users) and without having to wait for a history of accesses to determine access frequency, i.e., “popularity”.

System AP1 includes a data center 12, client computers 14, 15, and 16, and respective users 17, 18, and 19. Data center 12 includes processors 21, communications devices 23, and computer-readable storage media 25. Media 25 is encoded with code 40 defining an access controller 41, a replication controller 43, a load balancer 45, a usage monitor 47, a database 49 for storing usage data, a usage analyzer 51, and published objects. Media 25 includes disk storage and other media associated with storage nodes 31-36 and used for storing published objects, as well as system memory and other solid-state memory on data center servers on which functions 41-51 are executed. Access controller 41 governs access to data center 12, e.g., by client computers 14-16, in accordance with access policies 53. Replication controller 43 controls document replication according to replication policies 55.

Data center 12 provides for storing objects such as compressed and uncompressed electronic documents, multimedia objects, and executable files. For example, data center 12 is shown in FIG. 1 storing documents D1-D4. Document D1 is representative of large document files that are not accessed very often so that an interruption in its availability is not likely to be particularly problematic; it is therefore stored only in one storage node, namely, storage node 36. Document D2 is representative of moderately popular documents for which an interruption in availability might be problematic; document D2 is stored in two storage nodes 34 and 35. Document D3, which is stored in all nodes 31-36 is representative of objects that are very popular. Document D4 is also very popular in that it is frequently written to; however, to limit the burden of synchronizing replicas, it is stored in only a few nodes, e.g., nodes 31, 32, and 35. In general, each stored electronic object is replicated as determined by replication controller 43 in accordance with replication policies 55.

Data center 12 employs a distributed file system that allows each file to be independently replicated by a factor specified on a per-file basis. The file system is also responsible for detecting and recovering from storage node failures. For example, it will make new replicas of objects stored on a storage node in the event that the data node fails. The Hadoop file system (available from The Apache Software Foundation) is one example of a file system with these characteristics.

Documents and other objects can be published by submitting them for storage by data center 12. Access control policies 53 determine which users may access which objects; in addition, policies 53 determine what rights users permitted to access an object have. For example, some users may be permitted to edit a form, others may be permitted to fill in a form but not edit it, and still others may be restricted to viewing a completed form. In FIG. 1, user 14 is representative of users that can submit and edit documents D1-D4; user 15 is representative of users that have read-only access to documents D1-D4; and user 16 is representative of users that are not permitted to access documents D1-D4 (but may have rights to access other objects stored on data center 12). For each access type, user correlations can be used to predict the likely read and write access rates of a new object given its creator and access control policy. This information may be combined with other object characteristics to select a suitable replication number for each object to satisfy user demand without excessive cost

As mentioned above, it is generally desirable to provide more replicas of relatively popular documents. The “popularity” used for determining a replication value can be determined by tracking accesses to a published object. However, at the time the object is submitted and for some time afterwards, there will be insufficient access data to provide a measure of popularity, or access patterns. System AP1 allows the publisher to assign either a permanent or temporary replication value upon object publication. However, most user/publishers are not well versed in the tradeoffs involved in setting a replication value.

Accordingly, system AP1 uses the access control policy associated with the object upon publication to determine automatically an initial replication value; this initial value can be adjusted once sufficient access data is available to determine actual popularity. An access control policy defines what actions can be performed by which users on which objects. One example of implementing access control policy is by roles and is commonly known as role based access control (RBAC). In RBAC, a user is mapped to certain roles or users may be put into groups and then the members of the group are collectively assigned to a role. Policies are then written in such a way as to allow certain roles the privilege to read or write a document.

Data center 12 hosts data from several companies. Each company can have objects that are available to the public, but also can have objects that are restricted by access policies 53 to its employees or to a particular department or workgroup, etc. Access controller 41 maintains a list of eligible user names and their authentication tokens (e.g. passphrases or public PKI certificates) to control access to published objects.

When an object is submitted to replication controller 43, access controller 41 can inform replication controller of the number of users that can access the object. This number can be broken down accordingly to the access rights (e.g., read, write, delete) associated with each of the user names. Thus, replication controller 43 can assign a viable replication number upon publication, avoiding the need for a fixed default value pending sufficient actual access data to measure popularity. Because of concerns about maintaining isolation between different company's objects, it is possible for data center 12 to provision separate clusters of servers per customer or, for larger businesses, internal departments, or business units.

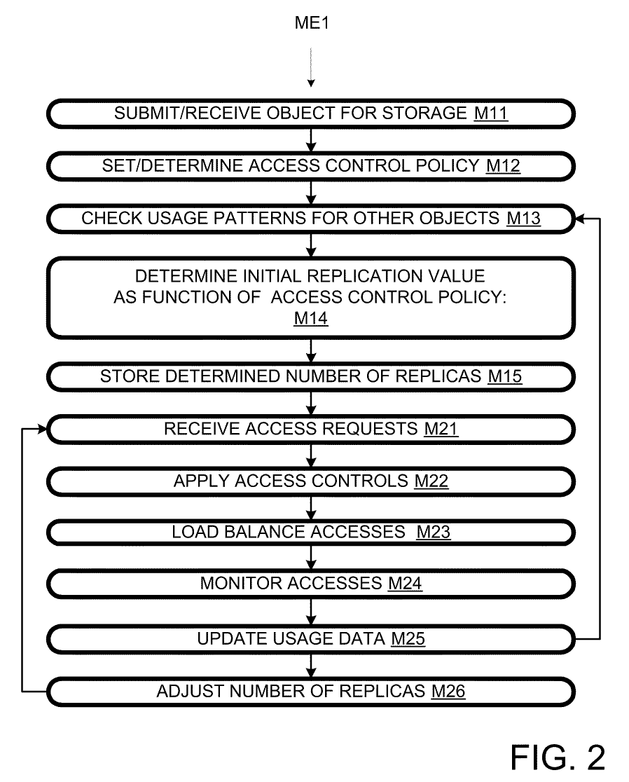

A method ME1 implemented in the context of the system is flow charted in FIG. 2. Method ME1 is triggered whenever a new object is stored by a user. The process is made up of several segments with loops. At method segment M11, an object is “published” by being submitted by a user and received by data center 12 for storage. For example, in FIG. 1, user 17, using client computer 14, can submit a document to data center 12. This submission is received by access controller 41.

At method segment M12, access controller 41 determines an access control policy for the object. In some cases, a new access control policy for the object can be submitted with the object. In other cases, the publisher can identify (e.g., from a list) an access control policy for the object. In still other cases, access controller 41 can automatically assign an access control policy, e.g., based on the account associated with the publisher. For example, access control policies 53 may specify that all objects submitted by user 17 restrict write access to a given workgroup, allow others, e.g., user 18, in their department read-only access, and exclude others, e.g., user 19. Thus, the numbers of users with write and read access can be determined from the number of users with user identities associated with the groups having write or read-only access.

Access control policies 53 provide for resolving the list of users with one or more access permissions for the object just stored. Ordinarily, a user requesting access to an object is first mapped to the roles they have; then, only if one or more of the roles has the requested access permission, will the user be granted access. In system AP1, the reverse of this is implemented. Given the roles that have been given access privileges to the object, determine the population of users and their access rights to the object. This is referred to here as the reverse user access lookup (RuaL).

At method segment M13, the record of usage patterns for existing objects can be checked. While there may be no access data for an object upon its publication, there may be access data for similar objects (e.g. similar in the sense that they are word documents stored in the same file system directory) with similar access policies that were previously published. If so, the access data for the previous objects can contribute to setting a replication factor for the object currently being published. For example, the popularity of documents previously published by user 17 can be considered in setting an initial replication number.

At method segment M14, replication controller 43 determines an initial replication value, indirectly, at least in part as a function of the access control policy of the object being published. From one perspective, replication controller 43 estimates popularity using the access control policy to determine the set of users with access to the object and, then, based on a history of their use of objects stored by the system computes a replication number using the estimated popularity for both read and write requests. Other factors, e.g., object size can also be considered in determining the replication value. This result was derived in M. Zhong, K. Shen, J. Seiferas, “Replication Degree Customization for High Availability,” EuroSys 2008.

Given a popularity and other characteristics of an object, a replication factor can be assigned to the object. The actual computation of the replication factor given certain known and estimated characteristics of the object could be performed by use of a simple table that maps sets of object characteristics to replication factors. The table would be pre-computed based on measured system performance data and optimized based on the specific system configuration and internal components.

At method segment M15, replication controller 43 causes the determined number of replicas of a submitted object to be stored in different nodes. In the process, replication controller 43 informs load balancer 45 of the locations for the newly stored object. For example, document D4 is stored on storage nodes 31, 32, and 35, but not on storage nodes 33, 34, and 36. Document D1, on the other hand, is stored only on storage node 36.

Once an object is stored, requests for access can be entertained, as at method segment M21. Access controls are applied at method segment M22. This can involve prohibiting unauthorized users from accessing an object and enforcing the type (e.g., read/write versus read-only) of access appropriate for the requesting user. The allowed accesses are distributed among the storage locations by load balancer 45 at method segment M23.

In the meantime, accesses are monitored at method segment M24. This involves usage monitor 47 tracking who (or what accounts) access what objects, how often they access the object, what type of access they make and under what conditions. As a result of this monitoring, usage data 49 is updated at method segment M25. Concurrently, usage analyzer 51 can analyze the usage data and update database 49 with statistical summaries. Once the accesses permit reliable measures of popularity, the number of replicas can be adjusted at method segment M26. In one approach the actual value for the popularity for an access or action type “a” on the document d can be updated according to

pop(a,d)=λã+(1−λ)a*

where ã is the estimate of popularity of action a for the document d and a* is the actual measured popularity for action a on document d. Action “a” can be either read or write accesses which are of primary concern to setting the replication factor. λ is a weighting factor which is initially set to 1 and is reduced to zero over time. The effect is to gradually adjust the popularity value (pop(a,d) from the initial estimate to the actual measured value.

As indicated by the return arrow from method segment M26 to method segment M21, method segments M21-M26 are iterated. Each published object is monitored under the method ME1. Also, the updated usage data obtained at method segment M25 can be used in determining replication values for subsequently published documents, as indicated by the return arrow to method segment M13.

[1] Referring back to method segment M13, based on the access control rules, identify all the users with at least one permission to perform an action on the newly created object. Let that set be U and let u(i) be the ith user. Let |U|=N (set size).

[2] For each member u(i) of U (i=1 . . . N), compute the similarity between the user u(c) who created the object and user u(i). The similarity measure between each pair of users u(x) and u(y) is defined as S(x,y) where 0<=S(x,y)<=1. An example function for S(x,y) could be the well known cosine similarity measure. Each set of user's interactions with the set of existing objects is represented by an activity vector with each entry containing the number of actions of all types performed on an object (each object is mapped to an index in the activity vector) by the user in a given time window. The cosine similarity measure is computed over the two activity vectors; in this case it can never be less than zero since all terms in the vectors are greater than or equal to zero. The values in the activity vector represent the sum of read and write actions. This is because a user, or set of users, may read the objects written by another user, and, if read and write actions were treated separately for the purposes of computing user similarities, then this type of important correlation would be scored very low.

[3] For each member u(i) of U, compute the average number of actions of each type carried out per unit time (over some specified time window) over all objects that have been acted on by either u(i) and u(c) in the past (up to some configurable time limit). This is computed based on a record of the user's prior actions and may be computed ahead of time during periods of low activity. Let the average number of actions of type ‘a’ per unit time by user u(i) be A(i,a). Action types are treated separately in this step, so in the previous example, if a user, u(i), only ever read objects written by u(c) and no other then the value of A(i,write) would be 0 for the objects written by u(c) which would mean no writes on a new object created by u(c) would be expected from u(i) which is the likely case.

[4] For each action, compute the number of expected actions of each type performed by u(i) on the object created by u(c) as E(i,a)=S(i,c)*A(i,a), where A(i,a) is the average number of actions of type ‘a’, per unit time, per object performed by user u(i). E(I,a) takes into account the correlation between users and the volume of activity generated by user u(i). If user u(i) is a new user, then there will not be much history to draw from. In this case, a virtual ‘average’ user is synthesized which is modeled by the average activity over all users in U and is used as the proxy for u(i) until such time as there is a long enough record of activity for u(i).

[5] Using results from step 4, compute the total number of expected actions over all users in the set U for each action type per unit time. This will then provide an estimate of the number each action expected over a given time window which can then be used to choose suitable replication factors from the replication algorithm. For action ‘a’ the total number of related requests, or popularity estimate, is given by

popₑₛₜ(action ‘a’ on obj created by c)=SUM(E(i,a))over i=1 . . . N.

[6] Based on the expected popularity of the object defined by the expected levels of actions that will be performed on the object, compute an appropriate replication factor (number), using a suitable replication algorithm. The similarity scores can be computed offline and updated periodically. Alternatively, example similarity metrics can be computed at the end of each day. A user may be an abstract entity like a process that creates objects automatically. For each object, the creator, or current user who owns the object, is recorded. Actions can be of type create, read, write, delete. More specific actions such as “fill-in” for a form are treated as write operations since they modify the object. Create and delete operations do not affect the popularity estimates.

It is possible to refine the algorithm above by more accurately modeling a user's actions on the set of objects in the system. For example, modeling the peak and minimum numbers of interactions or the variance in the number of interactions the user has with objects. Over time, the measured activity on the object can be used to adjust the replication factor for the object. Because behavior changes over time, the activity vectors and associated derived values can be windowed, and older records of activity can be dropped over time to allow the correlation between users to dynamically adapt to actual usage changes.

The monitoring and resulting statistical data can distinguish read and write access types. The replication controller can, based on the relative frequency of read and writes accesses, set the replication number such that a greater number of write accesses relative to read accesses reduces the number of object replicas whilst a lower number of write accesses relative to read accesses will result in an increased number of object replicas.

If an access control policy is changed, then the replication factor may be changed if the number of users able to access the object changes significantly. If the number of users increases substantially, then the replication factor can be raised quickly to prevent a risk of a bottleneck. For example, this could occur when the policy associated with an object is changed from a restricted editorial staff to a general publication made available to a broad general audience. When computing A(i,a) it may be necessary to limit the computation to the set of most recently (e.g. last few months) accessed objects by user u(i) and u(c) rather than all objects accessed by u(i) and u(c) because there are likely to be many objects that are not accessed frequently. For example, two colleagues working in the same department may have a high level of similarity, but if one colleague transfers to another business unit then the similarity will likely reduce. Thus by only considering the most recent objects, the system can adapt to changing user circumstances. These and other variations upon and modifications to the illustrated system and method are within the scope of the following claims.

What is claimed is:

1. A method comprising:
determining a replication number for an object at least in part as a function of an access control policy for that object; and
storing that number of replicas of said object.

2. A method as recited in claim 1 wherein said determining involves interpreting said access control policy is interpreted to determine users that are to be permitted to access said object and users that are to be excluded from accessing said object.

3. A method as recited in claim 2 wherein said determining involves interpreting said access control policy is interpreted to determine users that are to be allowed read-only access to said object and determines users that are to be allowed read-and-write access to said object.

4. A method as recited in claim 3 wherein said determining involves distinguishing read and write access types and based on the expected relative frequency of read and write accesses; and setting said replication number such that an expected greater number of write accesses relative to the expected number of read accesses results is a relatively lower number of object replicas whilst a lower number of expected write accesses relative to a number of expected read accesses results in a relatively greater number of object replicas.

5. A method as recited in claim 1 wherein said storing involves storing said object in computer-readable media of multiple storage nodes.

6. A method as recited in claim 1 wherein said determining is also a partial function of accesses by said permitted users of other objects.

7. A method as recited in claim 2 further comprising:
receiving requests for access to said object; and
applying said access controls so as to permit only permitted users to access said object.

8. A method as recited in claim 7 further comprising load balancing requests by permitted users so that different replicas of said object are accessed pursuant to different requests.

9. A method as recited in claim 8 further comprising:
monitoring accesses of said object;
updating usage data for said object; and
adjusting the number of replicas of said object as a function of said usage data.

10. A method as recited in claim 9 further comprising using said usage data for said object in determining replication values for other objects.

11. A system comprising computer-readable media encoded with code defining a replication controller that computes a replication number of replicas of an object to be stored at least in part as a function of access control policies.

12. A system as recited in claim 11 further comprising processors for executing said code.

13. A system as recited in claim 12 further comprising storage nodes for storing respective ones of said replicas.

14. A system as recited in claim 11 further comprising an access controller for controlling access to said object according to said access control policies.

15. A system as recited in claim 14 further comprising:
a usage monitor for tracking accesses of said object;
a usage database for storing data generated by said usage monitor; and
a usage analyzer for analyzing said usage to provide statistical data for storage in said database.

16. A system as recited in claim 15 wherein said replication controller adjusts said replication value in part as a function of said statistical data.

17. A system as recited in claim 15 wherein said replication controller provides for computing replication values for subsequently stored objects at least in part as a function of said statistical data.

18. A system as recited in claim 13 further comprising a load balancer for distributing requests for said object among said nodes according to said access control policies.

19. A system as recited in claim 16 wherein said access control policies distinguish between users with write access and users with read-only access.

20. A system as recited in claim 19 wherein:
said statistical data distinguishes read and write access types; and
based on the relative frequency of read and writes accesses, said replication controller sets said replication number such that a greater number of write accesses relative to a number of read accesses results in a relatively low replication number while whilst a lower number of write accesses relative to a number of read accesses results in a relatively greater replication number.
